(19) United States
(12) Patent Application Publication
(10) Pub. No.: US 2019/0380094 A1
(43) Pub. Date: Dec. 12, 2019

(54) TOKEN WAKEUP SIGNALING

(71) Applicant: QUALCOMM Incorporated, San Diego, CA (US)

(72) Inventors: Maarten Menzo Wentink, Nijmegen (NL); Albert Van Zelst, Woerden (NL); Jouni Malinen, Tuusula (FI); George Cherian, San Diego, CA (US); Alfred Asterjadhi, San Diego, CA (US)

(21) Appl. No.: 16/432,583

(22) Filed: Jun. 5, 2019

Related U.S. Application Data
(60) Provisional application No. 62/682,804, filed on Jun. 8, 2018.

(51) Int. Cl. H04W 52/02; H04L 5/00; H04W 68/00

(52) U.S. Cl. CPC H04W 52/0216; H04W 68/005; H04L 5/0055; H04W 52/0229

(57) ABSTRACT

Methods, systems, and devices for wireless communications are described. A wireless device may receive, via a management frame, a set of wakeup tokens for activating a main radio of the wireless device. The wakeup tokens may be unique to the wireless device and may be transmitted over a secure connection. An access point (AP) wishing to activate a main radio (e.g., for high throughput communications) may transmit a wakeup radio (WUR) frame, including a wakeup token from the set of wakeup tokens, to a secondary radio of the wireless device. The wireless device may, upon reception of the WUR frame, activate the main radio and transmit a wakeup acknowledgement (ACK) to the AP. The AP may then communicate with the wireless device via the main radio.

### CROSS REFERENCES

The present application for patent claims priority to U.S. Patent Application No. 62/682,804 by Wentink et al., entitled “TOKEN WAKEUP SIGNALING,” filed Jun. 8, 2018, assigned to the assignee hereof, and expressly incorporated by reference in its entirety herein.

### BACKGROUND

The following relates generally to wireless communications, and more specifically to token wakeup signaling.

Wireless communications systems are widely deployed to provide various types of communication content such as voice, video, packet data, messaging, broadcast, and so on. These systems may be multiple-access systems capable of supporting communication with multiple users by sharing available system resources (e.g., time, frequency, and power). A wireless network, for example a wireless local area network (WLAN), such as a Wi-Fi (i.e., Institute of Electrical and Electronics Engineers (IEEE) 802.11) network, may include an access point (AP) that may communicate with one or more stations (STAs) or mobile devices. The AP may be coupled to a network, such as the Internet, and may enable a mobile device to communicate via the network (or communicate with other devices coupled to the AP). A wireless device may communicate with a network device bi-directionally. For example, in a WLAN, a STA may communicate with an associated AP via downlink and uplink. The downlink (or forward link) may refer to the communication link from the AP to the STA and the uplink (or reverse link) may refer to the communication link from the STA to the AP.

A wireless device (e.g., a STA) may have a limited amount of battery power. During a sleep mode, a wireless device may periodically activate a radio, such as a WLAN transceiver, to communicate with an AP. In some examples, a wireless device may use a low power receiver (e.g., a wakeup radio (WUR)) to listen for and decode a wakeup message from an AP. The wakeup message may indicate whether communications are waiting at the AP to be transmitted to the wireless device. In some cases, however, the WUR may receive invalid or fake wakeup messages (e.g., a hacked or spoofed wakeup message from an attacking device), which may cause the device to wakeup and waste power resources.

### SUMMARY

The described techniques relate to improved methods, systems, devices, or apparatuses that support token wakeup signaling. Generally, the described techniques provide for secure transmission of wakeup radio (WUR) frames over an unsecured communication link. For example, a wireless device (e.g., a station (STA)) may receive, via a management frame, a set of wakeup tokens for activating a main radio of the wireless device. The wakeup tokens may be unique to the wireless device and may be transmitted over a secure connection. An access point (AP) wishing to activate a main radio (e.g., for high throughput communications) may transmit a WUR frame, including a wakeup token from the set of wakeup tokens, to a secondary radio (e.g., a low power radio) of the wireless device. The wireless device may, upon reception of the WUR frame, activate the main radio and transmit a wakeup acknowledgment (ACK) to the AP. The AP may then communicate with the wireless device via the main radio.

A method of wireless communications at an AP is described. The method may include transmitting a management frame to a STA via a main radio connection with the STA, where the management frame includes an indication of a set of wakeup tokens for the STA, transmitting a WUR paging frame to the STA via a WUR connection, where the WUR paging frame includes a wakeup token of the set of wakeup tokens for the STA, and withholding a data transmission to the STA until receiving via the main radio connection one or more of a response to the WUR paging frame or a keepalive signal.

An apparatus for wireless communications at an AP is described. The apparatus may include a first interface, a second interface, and a wireless modem coupled with the first interface and the second interface. The wireless modem may be configured to output over the first interface a management frame for transmission to a STA via a main radio connection with the STA, where the management frame includes an indication of a set of wakeup tokens for the STA, output over the first interface a WUR paging frame for transmission to the STA via a WUR connection, where the WUR paging frame includes a wakeup token of the set of wakeup tokens for the STA, and withhold a data transmission to the STA until obtaining over the second interface via the main radio connection one or more of a response to the WUR paging frame or a keepalive signal.

Another apparatus for wireless communications at an AP is described. The apparatus may include means for transmitting a management frame to a STA via a main radio connection with the STA, where the management frame includes an indication of a set of wakeup tokens for the STA, transmitting a WUR paging frame to the STA via a WUR connection, where the WUR paging frame includes a wakeup token of the set of wakeup tokens for the STA, and withholding a data transmission to the STA until receiving via the main radio connection one or more of a response to the WUR paging frame or a keepalive signal.

A non-transitory computer-readable medium storing code for wireless communications at an AP is described. The code may include instructions executable by a processor to transmit a management frame to a STA via a main radio connection with the STA, where the management frame includes an indication of a set of wakeup tokens for the STA, transmit a WUR paging frame to the STA via a WUR connection, where the WUR paging frame includes a wakeup token of the set of wakeup tokens for the STA, and withhold a data transmission to the STA until receiving via the main radio connection one or more of a response to the WUR paging frame or a keepalive signal.

Some examples of the method, apparatuses, and non-transitory computer-readable medium described herein may further include operations, features, means, or instructions for receiving a wakeup ACK frame from the STA in response to the WUR paging frame and transmitting the data transmission to the STA in response to the wakeup ACK frame.

Some examples of the method, apparatuses, and non-transitory computer-readable medium described herein may further include operations, features, means, or instructions for transmitting, to the STA, respective WUR paging frames for each wakeup token of the set of wakeup tokens.

Some examples of the method, apparatuses, and non-transitory computer-readable medium described herein may further include operations, features, means, or instructions for receiving a wakeup ACK frame from the STA in response to at least one of the respective WUR paging frames and transmitting the data transmission to the STA in response to the wakeup ACK frame.

Some examples of the method, apparatuses, and non-transitory computer-readable medium described herein may further include operations, features, means, or instructions for determining that the STA may be unresponsive based on a lack of response to each of the respective WUR paging frames, transmitting, to the STA, one or more secure wakeup frames including at least a portion of packet number, a STA identifier (ID), and a message integrity check (MIC), receiving, from the STA, a wakeup ACK frame in response to one of the one or more secure wakeup frames and transmitting the data transmission to the STA in response to the wakeup ACK frame.

Some examples of the method, apparatuses, and non-transitory computer-readable medium described herein may further include operations, features, means, or instructions for receiving a token ACK frame from the STA in response to the management frame, where the WUR paging frame may be transmitted based on the token ACK frame.

Some examples of the method, apparatuses, and non-transitory computer-readable medium described herein may further include operations, features, means, or instructions for selecting the set of wakeup tokens for the STA from a group of preconfigured wakeup tokens.

In some examples of the method, apparatuses, and non-transitory computer-readable medium described herein, transmitting the management frame may include operations, features, means, or instructions for transmitting a sequence number and a set size corresponding to the set of wakeup tokens.

Some examples of the method, apparatuses, and non-transitory computer-readable medium described herein may further include operations, features, means, or instructions for receiving a periodic keepalive message from the STA and transmitting an indication of a second set of wakeup tokens to the STA based on the periodic keepalive message.

In some examples of the method, apparatuses, and non-transitory computer-readable medium described herein, the wakeup token may be associated with an action to be performed by the STA.

In some examples of the method, apparatuses, and non-transitory computer-readable medium described herein, transmitting the WUR paging frame may include operations, features, means, or instructions for broadcasting the WUR paging frame to a group of STAs including the STA.

In some examples of the method, apparatuses, and non-transitory computer-readable medium described herein, transmitting the management frame may include operations, features, means, or instructions for generating a WUR mode field of the management frame, the WUR mode field including the indication of the set of wakeup tokens.

In some examples of the method, apparatuses, and non-transitory computer-readable medium described herein, transmitting the WUR paging frame may include operations, features, means, or instructions for generating a frame control field and a wakeup control field of the WUR paging frame, the wakeup control field indicating the wakeup token.

In some examples of the method, apparatuses, and non-transitory computer-readable medium described herein, the main radio connection may be a secure connection and the WUR connection may be an insecure connection.

In some examples of the method, apparatuses, and non-transitory computer-readable medium described herein, the set of wakeup tokens may be unique to the STA.

A method of wireless communications at a STA is described. The method may include receiving a management frame from an AP via a main radio connection with the AP, where the management frame includes an indication of a set of wakeup tokens for the STA, receiving a WUR paging frame from the AP via a WUR connection, where the WUR paging frame includes a wakeup token of the set of wakeup tokens for the STA, and transmitting a wakeup ACK frame to the AP via the main radio connection with the AP in response to the WUR paging frame.

An apparatus for wireless communications at a STA is described. The apparatus may include a first interface, a second interface, and a wireless modem. The wireless modem may configured to obtain over the first interface a management frame from an AP via a main radio connection with the AP, where the management frame includes an indication of a set of wakeup tokens for the STA, obtain over the first interface a WUR paging frame from the AP via a WUR connection, where the WUR paging frame includes a wakeup token of the set of wakeup tokens for the STA, and output over the second interface a wakeup ACK frame for transmission to the AP via the main radio connection with the AP in response to the WUR paging frame.

Another apparatus for wireless communications at a STA is described. The apparatus may include means for receiving a management frame from an AP via a main radio connection with the AP, where the management frame includes an indication of a set of wakeup tokens for the STA, receiving a WUR paging frame from the AP via a WUR connection, where the WUR paging frame includes a wakeup token of the set of wakeup tokens for the STA, and transmitting a wakeup ACK frame to the AP via the main radio connection with the AP in response to the WUR paging frame.

A non-transitory computer-readable medium storing code for wireless communications at a STA is described. The code may include instructions executable by a processor to receive a management frame from an AP via a main radio connection with the AP, where the management frame includes an indication of a set of wakeup tokens for the STA, receive a WUR paging frame from the AP via a WUR connection, where the WUR paging frame includes a wakeup token of the set of wakeup tokens for the STA, and transmit a wakeup ACK frame to the AP via the main radio connection with the AP in response to the WUR paging frame.

Some examples of the method, apparatuses, and non-transitory computer-readable medium described herein may further include operations, features, means, or instructions for receiving a data transmission from the AP in response to the wakeup ACK frame.

Some examples of the method, apparatuses, and non-transitory computer-readable medium described herein may further include operations, features, means, or instructions for identifying a sequence number and a set size corresponding to the set of wakeup tokens based on the indication of the set of wakeup tokens and generating the set of wakeup tokens based on the sequence number and the set size.

Some examples of the method, apparatuses, and non-transitory computer-readable medium described herein may further include operations, features, means, or instructions for transmitting a token ACK frame to the AP in response to the management frame, where the WUR paging frame may be received based on the token ACK frame.

Some examples of the method, apparatuses, and non-transitory computer-readable medium described herein may further include operations, features, means, or instructions for transmitting a periodic keepalive message to the AP and receiving an indication of a second set of wakeup tokens for the STA based on the periodic keepalive message.

In some examples of the method, apparatuses, and non-transitory computer-readable medium described herein, receiving the WUR paging frame may include operations, features, means, or instructions for receiving the WUR paging frame for a group of STAs including the STA via a broadcast channel.

Some examples of the method, apparatuses, and non-transitory computer-readable medium described herein may further include operations, features, means, or instructions for identifying an action associated with the wakeup token and performing the action.

In some examples of the method, apparatuses, and non-transitory computer-readable medium described herein, the main radio connection may be a secure connection and the WUR connection may be an insecure connection.

In some examples of the method, apparatuses, and non-transitory computer-readable medium described herein, the set of wakeup tokens may be unique to the STA.

### BRIEF DESCRIPTION OF THE DRAWINGS

FIG. 1 illustrates an example of a wireless communications system that supports token wakeup signaling in accordance with aspects of the present disclosure.

FIG. 2 illustrates an example of a wireless communications system that supports token wakeup signaling in accordance with aspects of the present disclosure.

FIG. 3 illustrates an example of a wakeup radio (WUR) frame that supports token wakeup signaling in accordance with aspects of the present disclosure.

FIG. 4 illustrates an example of a secure wakeup frame that supports token wakeup signaling in accordance with aspects of the present disclosure.

FIGS. 5 and 6 illustrate examples of a process flows that support token wakeup signaling in accordance with aspects of the present disclosure.

FIGS. 7 and 8 show block diagrams of devices that support token wakeup signaling in accordance with aspects of the present disclosure.

FIG. 9 shows a block diagram of a communications manager that supports token wakeup signaling in accordance with aspects of the present disclosure.

FIG. 10 shows a diagram of a system including a device that supports token wakeup signaling in accordance with aspects of the present disclosure.

FIGS. 11 and 12 show block diagrams of devices that support token wakeup signaling in accordance with aspects of the present disclosure.

FIG. 13 shows a block diagram of a communications manager that supports token wakeup signaling in accordance with aspects of the present disclosure.

FIG. 14 shows a diagram of a system including a device that supports token wakeup signaling in accordance with aspects of the present disclosure.

FIGS. 15 through 20 show flowcharts illustrating methods that support token wakeup signaling in accordance with aspects of the present disclosure.

### DETAILED DESCRIPTION

The described techniques relate to improved methods, systems, devices, or apparatuses that support token wakeup signaling techniques for wireless networks. In some cases, a device (e.g., a station (STA)) in a wireless network may include a main radio and a power limited (e.g., low power) radio. In order to conserve power, at least some of the devices in the system may be configurable to periodically utilize sleep periods for the main radio to reduce power consumption during which only the low power radio is active. The low power radio may be duty cycled during this time.

In some cases, a device may wake up its main radio during a sleep period. For example, an access point (AP) of the network may identify communications to be transmitted to a device (e.g., stored within a buffer). The wireless device may use a low power radio (e.g., a super regenerative receiver or wakeup radio (WUR)) to listen for and decode a wakeup token from other wireless devices. Upon receiving such a wakeup token, the device may activate a second radio (e.g., a main radio) for subsequent communication. That is, a wireless device may use the low power radio during sleep periods, and may wake up the second radio upon reception of the wakeup token.

The wakeup token may provide a secure method of waking up a device. Indications of wakeup tokens for a device may be transmitted over a secure connection and received over the main radio of the device. For example, an AP may transmit a set of wakeup tokens over a secure connection to the device. After acknowledging receipt of the set of wakeup tokens, the AP may transmit via the low power radio an indication of at least one of the set of wakeup tokens to the device in an attempt to wakeup the device (e.g., when data transmissions are pending for the device). The wakeup token received by the device may be compared to the set of wakeup tokens to validate the received wakeup token. In another example, an AP may transmit to a device over a secure connection a sequence number, a set size, or both, which correspond to a set of wakeup tokens. The AP and the device may pseudo-randomly generate a set of wakeup tokens based on the sequence number, the set size, or both. Generating the wakeup tokens may allow for less information (e.g., the sequence number) to be communicated via the main radio. Such techniques may conserve power and may allow the wireless device to wake up via secure methods.

Aspects of the disclosure are initially described in the context of a wireless communications system. Aspects of the disclosure are further described with reference to wakeup frames communicated in a wireless communications system and process flows. Aspects of the disclosure are further illustrated by and described with reference to apparatus diagrams, system diagrams, and flowcharts that relate to token wakeup signaling.

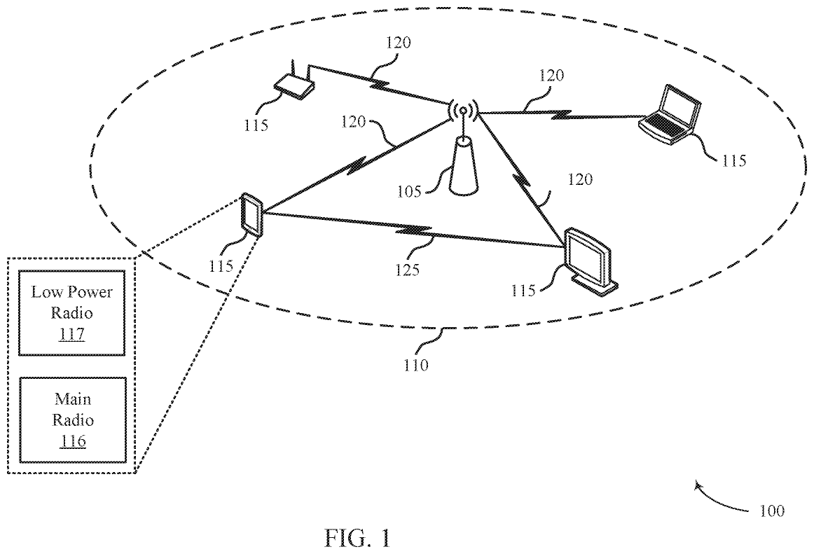

FIG. 1 illustrates a wireless communications system 100 such as a wireless local area network (WLAN) (also known as a Wi-Fi network) configured in accordance with aspects of the present disclosure. The wireless communications system 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). A single AP 105 and an associated set of STAs 115 may be referred to as a BSS. An ESS is a set of connected BSSs.

The various STAs 115 in the network are able to communicate with one another through the AP 105. Also shown is a coverage area 110 of the AP 105, which may represent a basic service area (BSA) of the wireless communications system 100. An extended network STA associated with the wireless communications system 100 may be connected to a wired or wireless distribution system that may allow multiple APs 105 to be connected in an ESS. In some examples, wireless communications system 100 may support token wakeup signaling between one or more devices, such as between an AP 105 and a STA 115.

Although not shown in FIG. 1, a STA 115 may be located in the intersection of more than one coverage area 110 and may associate with more than one AP 105. In some cases, the coverage area 110 of an AP 105 may be divided into sectors. The wireless communications system 100 may include APs 105 of different types (e.g., metropolitan area, home network, etc.), with varying and overlapping coverage areas 110. Two STAs 115 may communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and medium access control (MAC) layers from IEEE 802.11 and versions including, but not limited to, 802.11b, 802.11g, 802.11a, 802.11 In, 802.11ac, 802.11ad, 802.11ah, 802.11ax, 802.11ab, etc. In other implementations, peer-to-peer connections or ad hoc networks may be implemented within wireless communications system 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier-sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of an request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

A STA 115 may include a main radio 116 and a low power radio 117 for communication. The main radio 116 may be used during active modes (e.g., full power modes) or for high-data throughput applications. A low power radio 117 may be used during low power modes or for low-throughput applications. In some examples, the low power radio 117 may be a WUR or a wakeup receiver radio.

A STA 115 may listen using a WUR, such as low power radio 117, for a wakeup message or wakeup frame in a wakeup waveform. In some cases, STA 115 may receive a preamble having a first frequency band (e.g., wideband, such as on a 20 megahertz (MHz) channel) and a wakeup signal (e.g., a WUR signal) having a second frequency band (e.g., narrowband, such as a 4-5 MHz channel within the 20 MHz channel). Further, the low power radio 117 may share the same medium (e.g., frequency spectrum targeted for reception) as main radio 116. However, transmissions intended for low power radio 117 may be associated with lower data rates (e.g., tens or hundreds of kilobytes per second (kbps)).

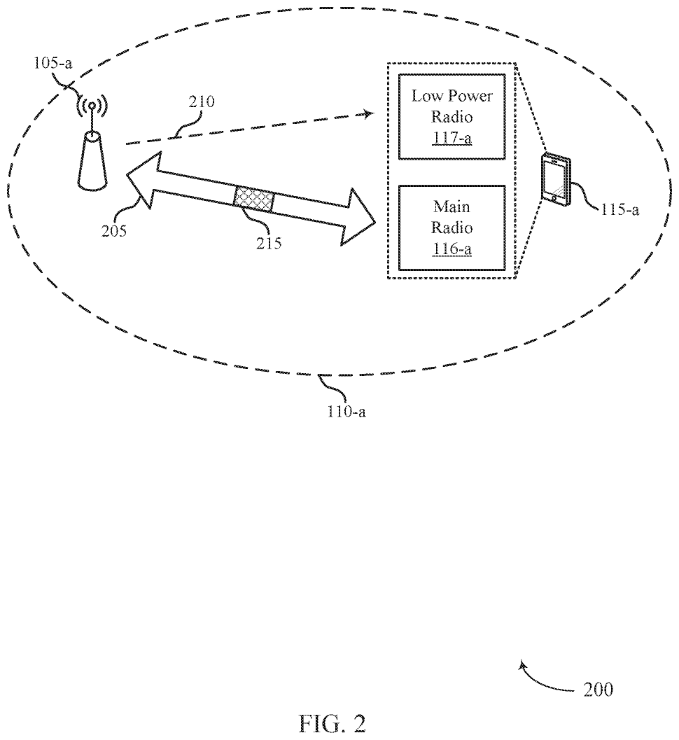

FIG. 2 illustrates an example of a wireless communications system 200 that supports token wakeup signaling in accordance with aspects of the present disclosure. In some examples, Wireless communications system 200 may implement aspects of wireless communications system 100. Wireless communications system 200 may include an AP 105-a and a STA 115-a, which may be examples of the corresponding devices described with reference to FIG. 1. STA 115-a may include a main radio 116-a and a low power radio 117-a (e.g., a WUR) for communication.

The main radio 116-a may be used during active modes or for high-data throughput applications (e.g., for full power transmissions or primary communications 205 from AP 105-a). The low power radio 117-a may be used during low power modes or for low-throughput applications (e.g., for wakeup transmissions 210 from AP 105-a). STA 115-a may receive wakeup transmissions and power additional circuitry (e.g., main radio 116-a). In some examples, the low power radio 117-a may be a WUR. The low power radio 117-a may listen for wakeup transmissions 210 (e.g., WUR frames) and wakeup the main radio 116-a of STA 115-a for primary communications 205 (e.g., full power, high-data throughput applications).

STA 115-a may wakeup its main radio 116-a after validating a wakeup token. The low power radio 117-a may receive a WUR frame from AP 105-a. The WUR frame may include a wakeup token from AP 105-a wishing to communicate with STA 115-a. STA 115-a may determine that the wakeup token matches one of the wakeup tokens received from AP 105-a. STA 115-a may then wake up its main radio 116-a for communicating with AP 105-a. If a received wakeup token cannot be determined to be one of the wakeup tokens received from AP 105-a, then STA 115-a may not wake up its main radio 116-a. In some cases, the wakeup token may be unique to STA 115-a, but in other examples, a wakeup token may be unique to a group of STAs including STA 115-a.

A wakeup token may be from a set of wakeup tokens. AP 105-a may transmit a set of wakeup token values (e.g., via a management frame 215) to STA 115-a over the main radio 116-a, which may be referred to as a set of active wakeup tokens. Main radio 116-a may provide a secure connection over which to transmit the set of wakeup token values. When AP 105-a attempts to wake up STA 115-a from a sleep mode, AP 105-a may send, to STA 115-a, a wakeup token via the low power radio 117-a from the set of tokens for STA 115-a. If STA 115-a does not respond (e.g., via the main radio 116-a) within a predetermined amount of time, AP 105-a may transmit another wakeup token in the set of wakeup tokens for STA 115-a. In some cases, a wakeup token may be transmitted only once (e.g., for security purposes). This procedure may repeat until the set of active wakeup tokens is depleted.

Alternatively, STA 115-a may receive a sequence number from AP 105-a in a management frame 215. The sequence number may act as a “seed” to pseudo-randomly generate a set of wakeup tokens. Both STA 115-a and AP 105-a may process the sequence number to generate the set of wakeup tokens. Transmitting the sequence number, rather than the set of wakeup tokens themselves, may reduce transmission resource usage in the system.

If the set of wakeup tokens is depleted, AP 105-a may wait for STA 115-a to transmit a keepalive signal to receive a new set of wakeup tokens. The keepalive signal may be periodic and may be transmitted via the main radio 116-a of STA 115-a. After reception of a keepalive signal, AP 105-a may transmit to the main radio 116-a of STA 115-a a new set of wakeup tokens or a new sequence number to STA 115-a. In some cases, AP 105-a or STA 115-a may determine the keepalive signal interval for STA 115-a based on the capabilities of STA 115-a or the intended maximum occurrence rate of active token depletion events.

Alternatively, AP 105-a may transmit a secure wakeup frame to STA 115-a once the set of active tokens is depleted and no response has been received from STA 115-a. The secure wakeup frame may be transmitted to the low power radio 117-a. A cryptographic key shared between STA 115-a and AP 105-a may determine a message integrity check (MIC) field of the secure wakeup frame (e.g., the cryptographic key acts as a checksum). STA 115-a may determine the validity of the secure wakeup frame based at least on the MIC field. Upon validation, STA 115-a may activate its main radio 116-a and transmit a secure wakeup frame acknowledgment (ACK) to AP 105-a. After receiving a secure wakeup frame ACK, AP 105-a may transmit a primary (e.g., full power, data) communications 205 to STA 115-a.

The secure wakeup frame may have additional fields compared to a WUR frame. However, these additional fields may be used to validate the secure wakeup frame as authentic. The secure wakeup frame may include at least a (partial) packet number (PN) field, a station identifier (STA ID) field, and a MIC field. Additionally, the secure wakeup frame may further include an AP identifier (AP ID) field.

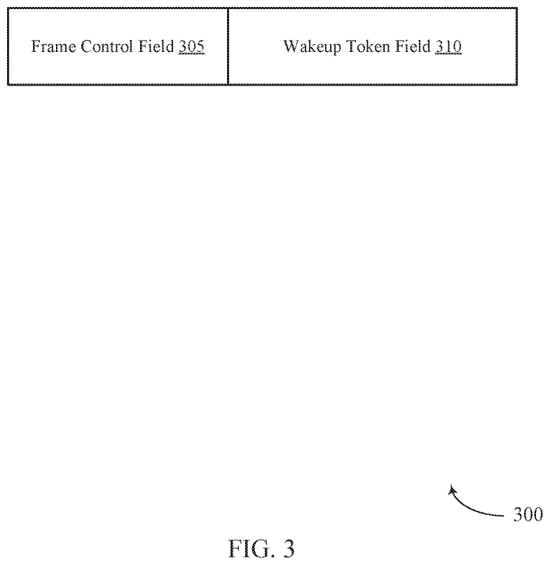

FIG. 3 illustrates an example of a WUR frame 300 that supports token wakeup signaling in accordance with aspects of the present disclosure. In some examples, WUR frame 300 may be implemented through techniques or aspects of wireless communications systems 100 or 200. For example, WUR frame 300 may be transmitted by an AP 105 as described with reference to FIGS. 1 and 2 and the WUR frame 300 may be received by a STA 115 as described with reference to FIGS. 1 and 2. According to some aspects, the WUR frame 300 may include a frame control field 305 and a wakeup token field 310.

The frame control field 305 may identify the frame as a WUR frame 300. In some examples, the frame control field 305 may include 8 bits (e.g., bits B0 through B7). Additionally or alternatively, the bit size of the frame control field 305 may be determined by the AP 105 based on the capabilities of the STA 115 to which the WUR frame 300 is being transmitted. The size of the frame control field 305 may be signaled (e.g., via control transmissions over a main radio) to the STA 115 prior to transmission of the WUR frame 300.

The wakeup token field 310 may identify the STA 115 to which the WUR frame 300 is transmitted. In some examples, the wakeup token field 310 may be 32 bits (e.g., bits B8 through B39). Additionally or alternatively, the bit size of the wakeup token field 310 may be determined by AP 105 based on the capabilities of the STA 115 to which the WUR frame 300 is being transmitted as well as the size of the set of wakeup tokens to be used (e.g., a larger set of wakeup tokens may require a larger bit size of the wakeup token field 310). The size of the wakeup token field 310 may be signaled (e.g., via control transmissions over the main radio) to the STA 115 prior to transmission of the WUR frame 300. In some embodiments, the wakeup token frame may include a 3 bit frame type field identifying the frame as a wakeup token frame, and a 29 bit wakeup token, for a total size of 32 bits.

According to some aspects, several different field types may be excluded based on the structure of the WUR frame 300. For example, the WUR frame 300 may have a fixed length, and therefore a length field may be excluded. Additionally, as the entirety of the wakeup token field 310 may be validated (e.g., matching one from the set of wakeup tokens as described in FIG. 2), a frame check sequence (FCS) may be excluded from the WUR frame 300. As another example, if the wakeup token field 310 is unique to the STA, a STA ID may be excluded. As such, the bit size of the WUR frame 300 may be reduced, which may allow for power savings and lower complexity at the device decoding the WUR frame 300.

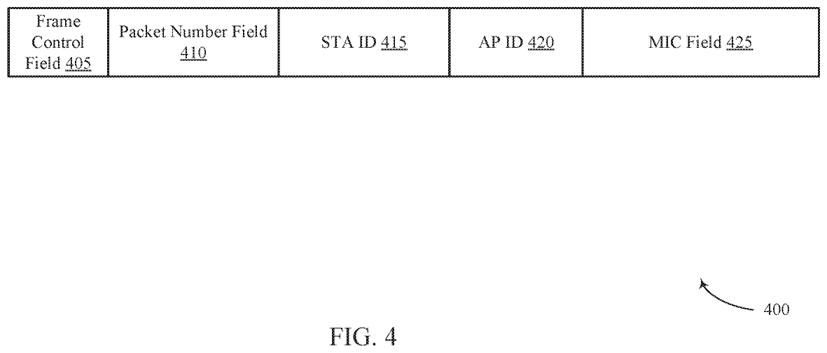

FIG. 4 illustrates an example of a secure wakeup frame 400 that supports token wakeup signaling in accordance with aspects of the present disclosure. In some examples, secure wakeup frame 400 may be implemented through techniques or aspects of wireless communications systems 100 or 200. For example, the secure wakeup frame 400 may be transmitted by an AP 105 as described with reference to FIGS. 1 and 2 and the secure wakeup frame 400 may be received by a STA 115 as described with reference to FIGS. 1 and 2. According to some aspects, the secure wakeup frame 400 may include a frame control field 405, a PN field 410, a STA ID field 415, an AP ID field 420, and a MIC field 425.

The frame control field 405 may identify the frame as a secure wakeup frame 400. In some examples, the frame control field 405 may include 8 bits (e.g., bits B0 through B7). Additionally or alternatively, the bit size of the frame control field 405 may be determined by the AP 105 based on the capabilities of the STA 115 to which the secure wakeup frame 400 is being transmitted. The size of the frame control field 405 may be signaled (e.g., via control transmissions over the main radio) to the STA 115 prior to transmission of the secure wakeup frame 400.

The PN field 410 may include a PN for the secure wakeup frame 400. A PN may be a unique number for each secure wakeup frame 400 transmitted. In some cases, the PN may be a partial PN. In these cases, a synchronization process (e.g., a rollover procedure such as that which may be defined for protocol version 1 (PVI) in 802.11) may be implemented between AP 105 and STA 115.

The STA ID field 415 may contain a STA ID. The STA ID may be a unique value (e.g., a 12-bit value) which identifies the STA 115 within the context of its AP 105. Additionally, an AP ID field 420 may contain an AP ID. The AP ID may be a unique value which identifies AP 105.

The MIC field 425 may contain a MIC value. The MIC value may be a cryptographic checksum which the STA 115 may process to validate the fields of the secure wakeup frame 400 (e.g., fields 405-425 or at least PN field 410 and STA ID field 415).

It is to be understood that various field sizes and locations with secure wakeup frame 400 are considered without departing from the scope of the disclosure. A table representing example bit lengths for the secure wakeup frame is provided below:

TABLE 1
Example bit lengths for a secure wakeup frame

| | Field Size | First | Last |
|---|---|---|---|
| Field Name | (bits) | Bit | Bit |
| Frame Control (FC) | 8 | 0 | 7 |
| Packet Number (PN) | 16 | 8 | 23 |
| STA ID | 12 | 24 | 35 |
| AP ID | 12 | 36 | 47 |
| Message Integrity Check (MIC) | 32 | 48 | 79 |

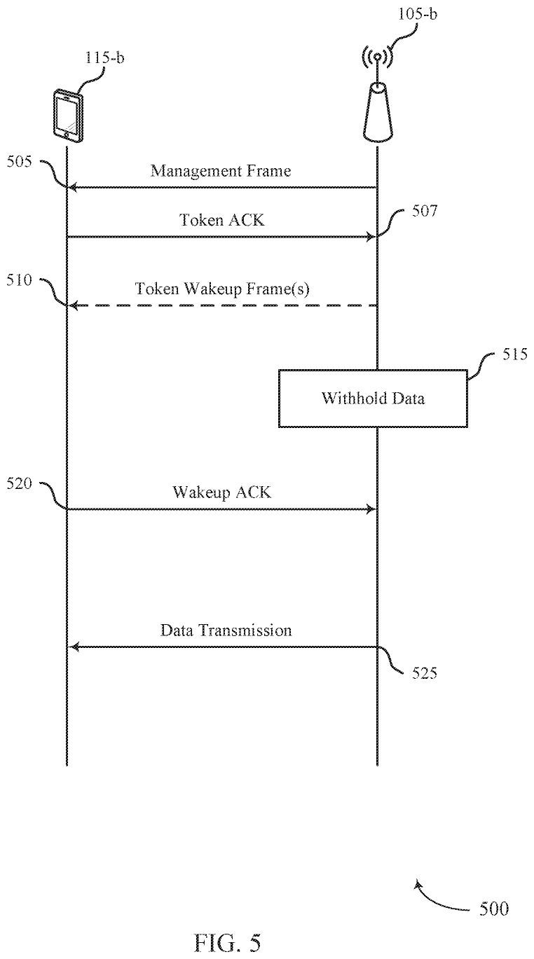

FIG. 5 illustrates an example of a process flow 500 that supports token wakeup signaling in accordance with aspects of the present disclosure. In some examples, process flow 500 may implement aspects of wireless communications systems 100 or 200. Process flow 500 may include a STA 115-b and an AP 105-b, which may be examples of the corresponding devices described with reference to FIGS. 1 and 2.

At 505, AP 105-b may transmit a management frame to STA 115-b via a main radio connection with the STA 115-b. The management frame may include an indication of a set of wakeup tokens for the STA 115-b. In some cases, the management frame may include the set of wakeup tokens. Alternatively, the management frame may include a sequence number and a set size corresponding to the set of wakeup tokens.

At 507, after receipt of the management frame, STA 115-b may transmit a token ACK message to the AP 105-b to acknowledge successful receipt and decoding of the management frame transmitted at 505.

At 510, AP 105-b may transmit one or more token wakeup frames via a WUR connection. A token wakeup frame may include or indicate a wakeup token of the set of wakeup tokens for the STA 115-b. In some cases, the token wakeup frame is received after STA 115-b transmits the token ACK frame at 507.

At 515, AP 105-b may withhold a data transmission for the STA 115-b until AP 105-b receives a response to one of the one or more token wakeup frames or a keepalive signal from the STA 115. The data may be stored in a buffer at the AP 105-b until STA 115-b wakes up. AP 105-b may have been withholding a data transmission for the STA 115-b from the moment STA 115-b entered power save mode on the main radio connection.

At 520, STA 115-b may transmit, and AP 105-b may receive, a wakeup ACK frame in response to at least one of the token wakeup frames. The wakeup ACK frame may be transmitted by STA 115-b over the main radio connection and may indicate to the AP 105-b that the STA 115-b is awake.

At 525, AP 105-b may transmit, and STA 115-b may receive, the data transmission that was previously withheld at 515 based on receipt of the wakeup ACK frame at 520.

It is to be understood that the operations, steps, procedure, etc. illustrated by process flow 500 may be performed in any order or by various devices of a wireless communications system. Thus, the present disclosure is not limited to the example order shown in FIG. 5.

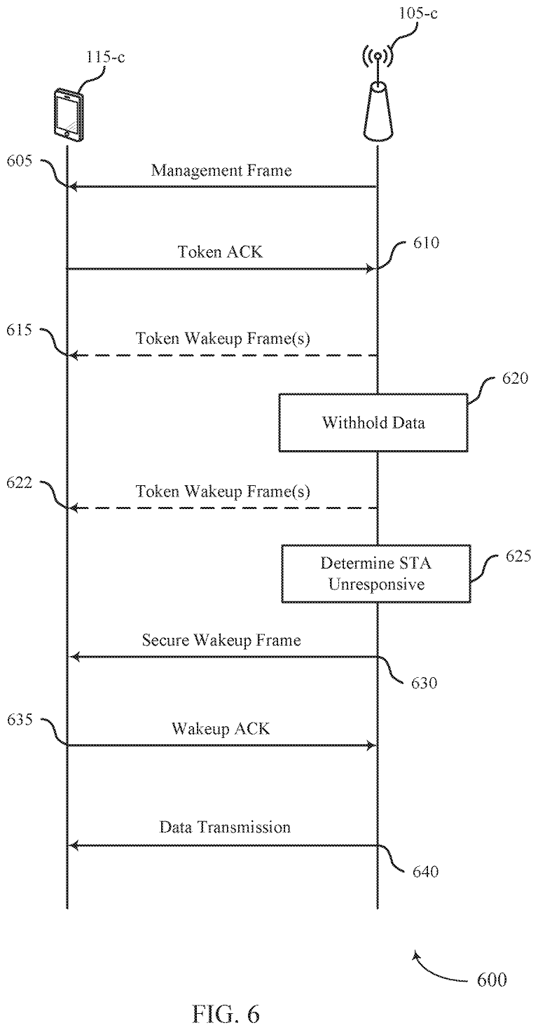

FIG. 6 illustrates an example of a process flow 600 that supports token wakeup signaling in accordance with aspects of the present disclosure. Process flow 600 may include a STA 115-c and an AP 105-c, which may be examples of the corresponding devices described with reference to FIGS. 1 and 2.

At 605, AP 105-c may transmit a management frame to STA 115-c via a main radio connection with the STA 115-c. The management frame may include an indication of a set of wakeup tokens for the STA 115-c. In some cases, the management frame may include the set of wakeup tokens. Alternatively, the management frame may include a sequence number and a set size corresponding to the set of wakeup tokens.

At 610, after receipt of the management frame, STA 115-c may transmit a token ACK message to the AP 105-c to acknowledge successful receipt and decoding of the management frame transmitted at 605.

At 615, AP 105-c may transmit to STA 115-c one or more token wakeup frames in an attempt to wake up STA 115-c.

At 620, AP 105-c may withhold a data transmission for the STA 115-c until AP 105-c receives a response to one or more of the token wakeup frames or a keepalive signal. For example, may transmit a token wakeup frame at 615 and after a period of time of no response from STA 115-c, the AP 105-c may transmit another token wakeup frame at 622. The AP 105-c may continue this process until all the wakeup tokens have been depleted (e.g., the AP 105-c may transmit a number of token wakeup frames corresponding to the number of wakeup tokens associated with the STA 115-c, each token wakeup frame associated with a respective wakeup token of the STA 115-c.

At 625, AP 105-c may determine that STA 115-c is unresponsive based on the lack of response to each of the respective token wakeup frames.

At 630, AP 105-c may transmit, and STA 115-c may receive, a secure wakeup frame. The secure wakeup frame may include at least a portion of a packet number, a STA ID, and a MIC.

At 635, STA 115-c may transmit, and AP 105-c may receive, a wakeup ACK frame in response to the secure wakeup frame.

At 640, AP 105-c may transmit, and STA 115-c may receive, the data transmission in response to the wakeup ACK frame.

It is to be understood that the operations, steps, procedure, etc. illustrated by process flow 600 may be performed in any order or by various devices of a wireless communications system. Thus, the present disclosure is not limited to the example order shown in FIG. 6.

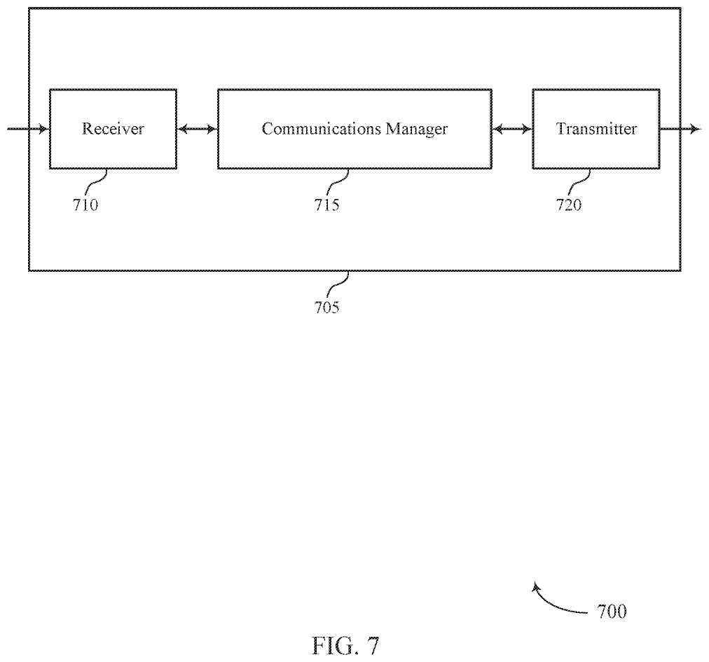

FIG. 7 shows a block diagram 700 of a device 705 that supports token wakeup signaling in accordance with aspects of the present disclosure. The device 705 may be an example of aspects of an AP 105 as described herein. The device 705 may include a receiver 710, a communications manager 715, and a transmitter 720. The device 705 may also include a processor. Each of these components may be in communication with one another (e.g., via one or more buses).

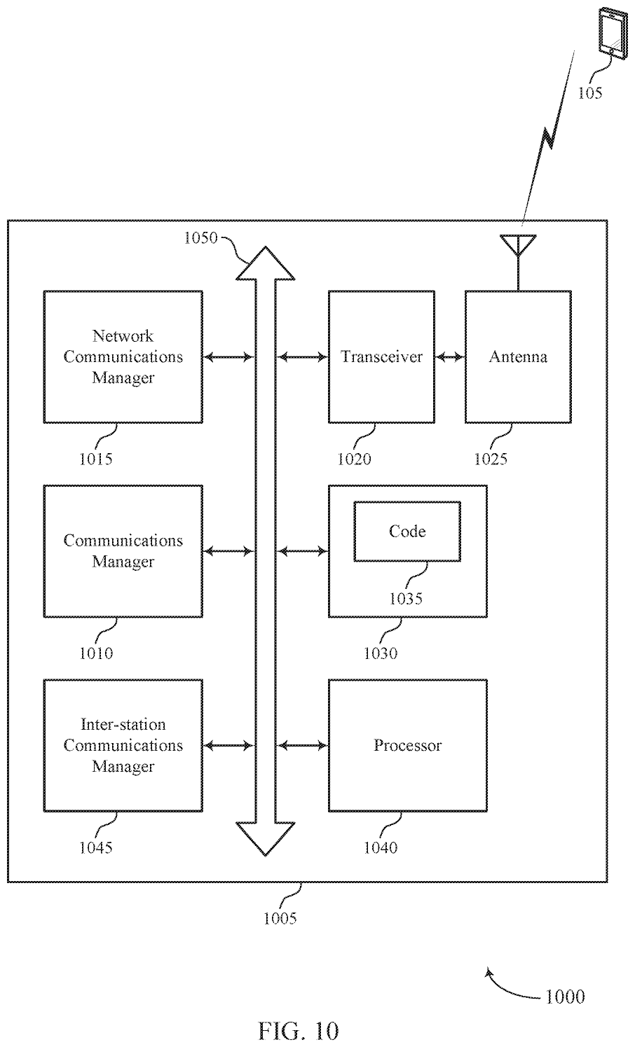

The receiver 710 may receive information such as packets, user data, or control information associated with various information channels (e.g., control channels, data channels, and information related to token wakeup signaling, etc.). Information may be passed on to other components of the device. The receiver 710 may be an example of aspects of the transceiver 1020 described with reference to FIG. 10. The receiver 710 may utilize a single antenna or a set of antennas.

The communications manager 715 may transmit a management frame to a STA 115 via a main radio connection with the STA 115, where the management frame includes an indication of a set of wakeup tokens for the STA 115 and transmit a WUR paging frame to the STA via a WUR connection, where the WUR paging frame includes a wakeup token of the set of wakeup tokens for the STA 115. The communications manager 715 may withhold a data transmission to the STA 115 until receiving via the main radio connection one or more of a response to the WUR paging frame or a keepalive signal. The communications manager 715 may be an example of aspects of the communications manager 1010 described herein.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

In some examples, the communications manager 715 may be implemented as a wireless modem chipset, and the transmitter 720 and the receiver 710 may be implemented as a set of analog components (e.g., amplifiers, filters, phase shifters, etc.) that are controlled by the communications manager 715 to transmit and receive signals, respectively. The communications manager 715 may couple with the receiver 710 over a receive interface and with the transmitter 720 over a transmit interface.

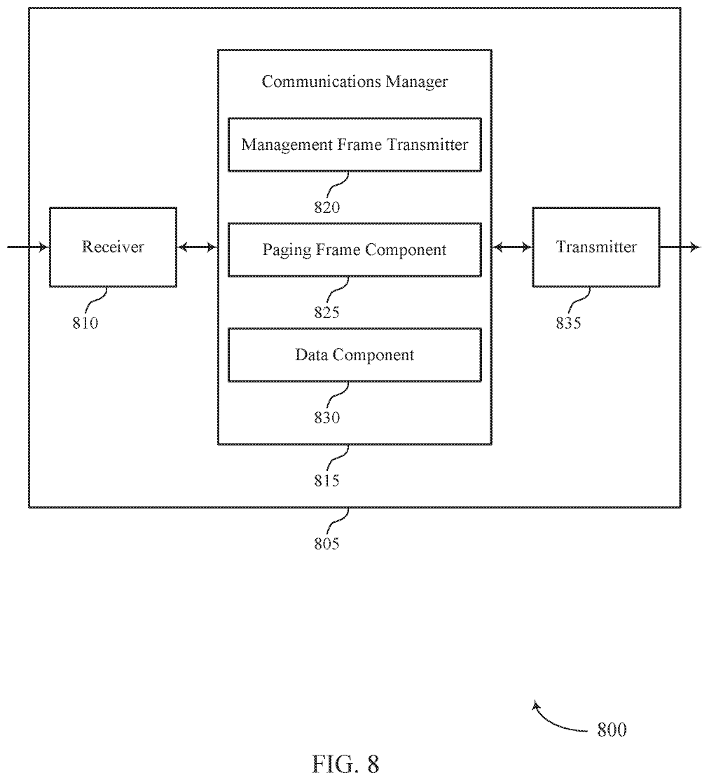

FIG. 8 shows a block diagram 800 of a device 805 that supports token wakeup signaling in accordance with aspects of the present disclosure. The device 805 may be an example of aspects of a device 705 or an AP 105 as described herein. The device 805 may include a receiver 810, a communications manager 815, and a transmitter 835. The device 805 may also include a processor. Each of these components may be in communication with one another (e.g., via one or more buses).

The receiver 810 may receive information such as packets, user data, or control information associated with various information channels (e.g., control channels, data channels, and information related to token wakeup signaling). Information may be passed on to other components of the device. The receiver 810 may be an example of aspects of the transceiver 1020 described with reference to FIG. 10. The receiver 810 may utilize a single antenna or a set of antennas.

The communications manager 815 may be an example of aspects of the communications manager 715 as described herein. The communications manager 815 may include a management frame transmitter 820, a paging frame component 825, and a data component 830. The communications manager 815 may be an example of aspects of the communications manager 1010 described herein.

The management frame transmitter 820 may transmit a management frame to a STA 115 via a main radio connection with the STA 115, where the management frame includes an indication of a set of wakeup tokens for the STA 115.

The paging frame component 825 may transmit a WUR paging frame to the STA 115 via a WUR connection, where the WUR paging frame includes a wakeup token of the set of wakeup tokens for the STA 115.

The data component 830 may withhold a data transmission to the STA 115 until receiving via the main radio connection one or more of a response to the WUR paging frame or a keepalive signal.

The transmitter 835 may transmit signals generated by other components of the device. In some examples, the transmitter 835 may be collocated with a receiver 810 in a transceiver module. For example, the transmitter 835 may be an example of aspects of the transceiver 1020 described with reference to FIG. 10. The transmitter 835 may utilize a single antenna or a set of antennas.

In some examples, the communications manager 815 may be implemented as a wireless modem chipset, and the transmitter 835 and the receiver 810 may be implemented as a set of analog components (e.g., amplifiers, filters, phase shifters, etc.) that are controlled by the communications manager 815 to transmit and receive signals, respectively. The communications manager 815 may couple with the receiver 810 over a receive interface and with the transmitter 835 over a transmit interface.

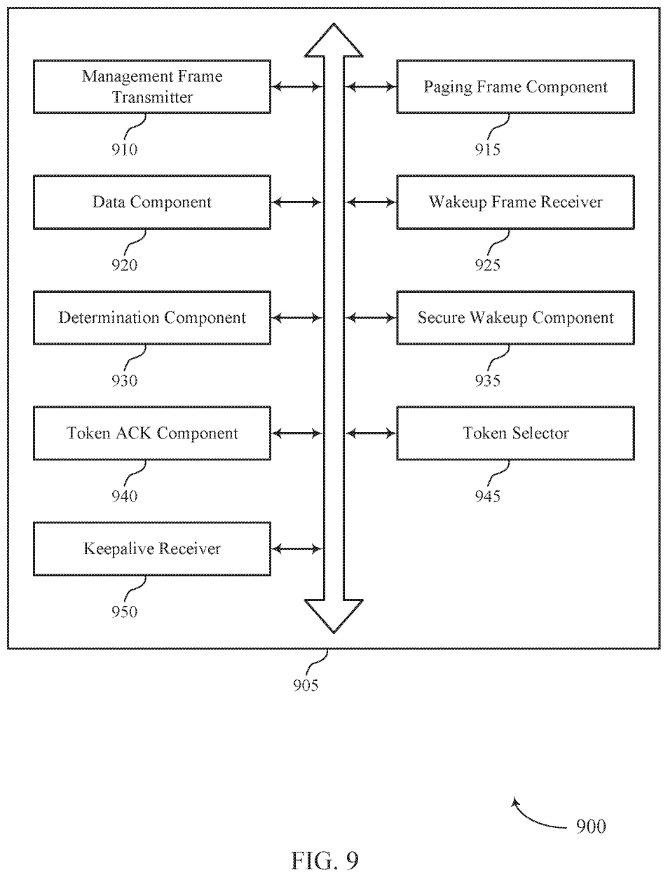

FIG. 9 shows a block diagram 900 of a communications manager 905 that supports token wakeup signaling in accordance with aspects of the present disclosure. The communications manager 905 may be an example of aspects of a communications manager 715, a communications manager 815, or a communications manager 1010 described herein. The communications manager 905 may include a management frame transmitter 910, a paging frame component 915, a data component 920, a wakeup frame receiver 925, a determination component 930, a secure wakeup component 935, a token ACK component 940, a token selector 945, and a keepalive receiver 950. Each of these modules may communicate, directly or indirectly, with one another (e.g., via one or more buses).

The management frame transmitter 910 may transmit a management frame to a STA 115 via a main radio connection with the STA, where the management frame includes an indication of a set of wakeup tokens for the STA. In some examples, the management frame transmitter 910 may transmit a sequence number and a set size corresponding to the set of wakeup tokens. In some cases, the management frame transmitter 910 may transmit an indication of a second set of wakeup tokens to the STA 115 based on the periodic keepalive message. In some aspects, the management frame transmitter 910 may generate a WUR mode field of the management frame, the WUR mode field including the indication of the set of wakeup tokens. In some instances, the management frame transmitter 910 may generate a frame control field and a wakeup control field of the WUR paging frame, the wakeup control field indicating the wakeup token. In some examples, the main radio connection is a secure connection. In some cases, the set of wakeup tokens is unique to the STA 115.

The paging frame component 915 may transmit a WUR paging frame to the STA 115 via a WUR connection, where the WUR paging frame includes a wakeup token of the set of wakeup tokens for the STA 115. In some examples, the paging frame component 915 may transmit, to the STA 115, respective WUR paging frames for each wakeup token of the set of wakeup tokens. In some aspects, the paging frame component 915 may broadcast the WUR paging frame to a group of STAs 115 including the STA 115. In some instances, the wakeup token is associated with an action to be performed by the STA 115. In some cases, the WUR connection is an insecure connection.

The data component 920 may withhold a data transmission to the STA 115 until receiving via the main radio connection one or more of a response to the WUR paging frame or a keepalive signal. In some examples, the data component 920 may transmit the data transmission to the STA 115 in response to the wakeup ACK frame.

The wakeup frame receiver 925 may receive a wakeup ACK frame from the STA in response to the WUR paging frame. In some examples, the wakeup frame receiver 925 may receive a wakeup ACK frame from the STA 115 in response to at least one of the respective WUR paging frames. In some cases, the wakeup frame receiver 925 may receive, from the STA 115, a wakeup ACK frame in response to one of the one or more secure wakeup frames.

The determination component 930 may determine that the STA 115 is unresponsive based on a lack of response to each of the respective WUR paging frames.

The secure wakeup component 935 may transmit, to the STA 115, one or more secure wakeup frames including at least a portion of packet number, a STA ID, and a MIC.

The token ACK component 940 may receive a token ACK frame from the STA 115 in response to the management frame, where the WUR paging frame is transmitted based on the token ACK frame.

The token selector 945 may select the set of wakeup tokens for the STA 115 from a group of preconfigured wakeup tokens.

The keepalive receiver 950 may receive a periodic keepalive message from the STA.

FIG. 10 shows a diagram of a system 1000 including a device 1005 that supports token wakeup signaling in accordance with aspects of the present disclosure. The device 1005 may be an example of or include the components of device 705, device 805, or an AP 105 as described herein. The device 1005 may include components for bi-directional voice and data communications including components for transmitting and receiving communications, including a communications manager 1010, a network communications manager 1015, a transceiver 1020, an antenna 1025, memory 1030, a processor 1040, and an inter-station communications manager 1045. These components may be in electronic communication via one or more buses (e.g., bus 1050).

The communications manager 1010 may transmit a management frame to a STA 115 via a main radio connection with the STA 115, where the management frame includes an indication of a set of wakeup tokens for the STA 115 and transmit a WUR paging frame to the STA 115 via a WUR connection, where the WUR paging frame includes a wakeup token of the set of wakeup tokens for the STA 115. The communications manager 1010 may withhold a data transmission to the STA 115 until receiving via the main radio connection one or more of a response to the WUR paging frame or a keepalive signal.

The network communications manager 1015 may manage communications with the core network (e.g., via one or more wired backhaul links). For example, the network communications manager 1015 may manage the transfer of data communications for client devices, such as one or more STAs 115.

The transceiver 1020 may communicate bi-directionally, via one or more antennas, wired, or wireless links as described herein. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include random-access memory (RAM) and read-only memory (ROM). The memory 1030 may store computer-readable, computer-executable code 1035 including instructions that, when executed, cause the processor to perform various functions described herein. In some cases, the memory 1030 may contain, among other things, a basic I/O system (BIOS) which may control basic hardware or software operation such as the interaction with peripheral components or devices.

The processor 1040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into processor 1040. The processor 1040 may be configured to execute computer-readable instructions stored in a memory to perform various functions (e.g., functions or tasks supporting token wakeup signaling).

The inter-station communications manager 1045 may manage communications with other AP 105, and may include a controller or scheduler for controlling communications with STAs 115 in cooperation with other APs 105. For example, the inter-station communications manager 1045 may coordinate scheduling for transmissions to STAs 115 for various interference mitigation techniques such as beamforming or joint transmission. In some examples, the inter-station communications manager 1045 may provide an X2 interface within an LTE/LTE-A wireless communication network technology to provide communication between APs 105.

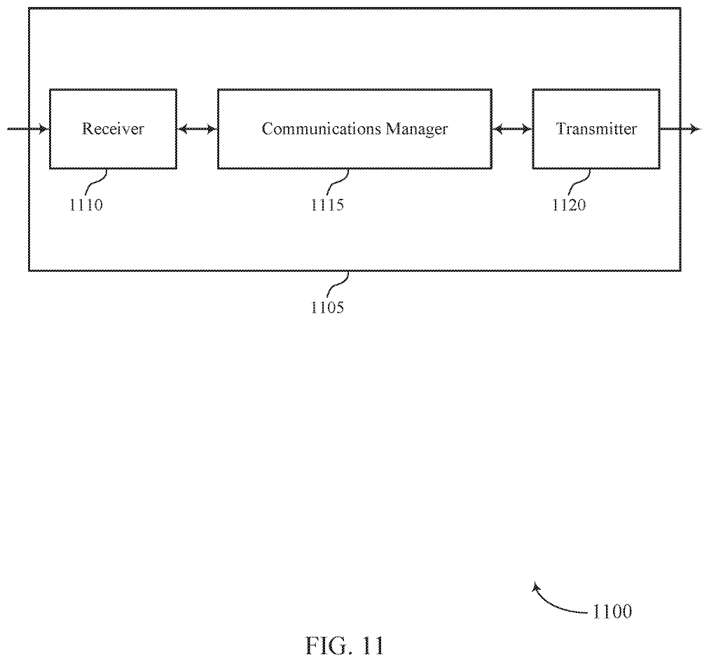

FIG. 11 shows a block diagram 1100 of a device 1105 that supports token wakeup signaling in accordance with aspects of the present disclosure. The device 1105 may be an example of aspects of a STA 115 as described herein. The device 1105 may include a receiver 1110, a communications manager 1115, and a transmitter 1120. The device 1105 may also include a processor. Each of these components may be in communication with one another (e.g., via one or more buses).

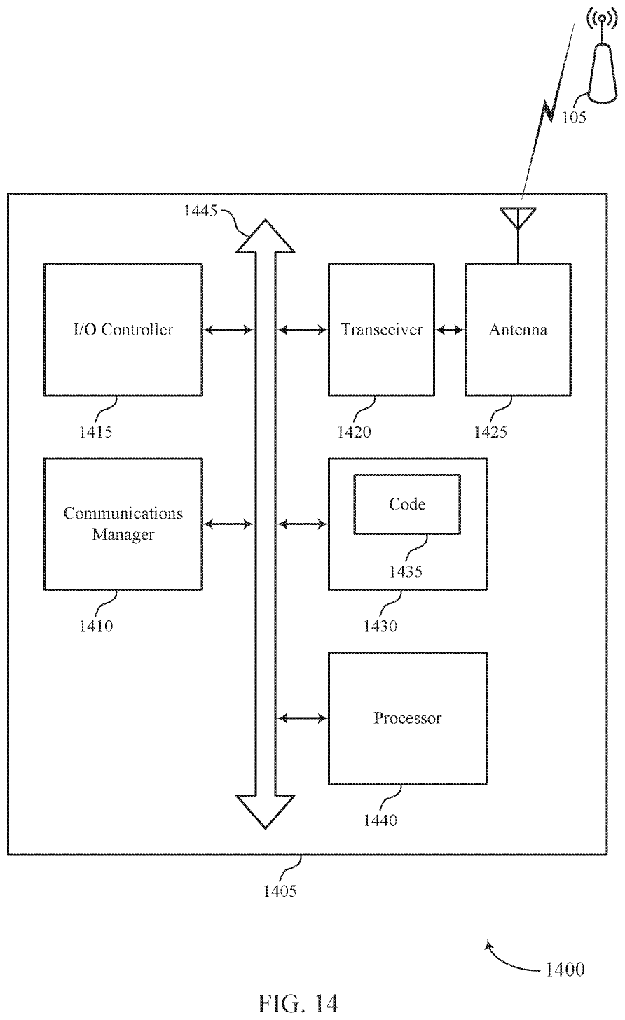

Receiver 1110 may receive information such as packets, user data, or control information associated with various information channels (e.g., control channels, data channels, and information related to token wakeup signaling, etc.). Information may be passed on to other components of the device. The receiver 1110 may be an example of aspects of the transceiver 1420 described with reference to FIG. 14. The receiver 1110 may utilize a single antenna or a set of antennas.

The communications manager 1115 may receive a management frame from an AP 105 via a main radio connection with the AP, where the management frame includes an indication of a set of wakeup tokens for the STA 115 and receive a WUR paging frame from the AP 105 via a WUR connection, where the WUR paging frame includes a wakeup token of the set of wakeup tokens for the STA 115. The communications manager 1115 may transmit a wakeup ACK frame to the AP 105 via the main radio connection with the AP 105 in response to the WUR paging frame. The communications manager 1115 may be an example of aspects of the communications manager 1410 described herein.

The communications manager 1115, or its sub-components, may be implemented in hardware, code (e.g., software or firmware) executed by a processor, or any combination thereof. If implemented in code executed by a processor, the functions of the communications manager 1115, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 1115, or its sub-components, may be physically located at various positions, including being distributed such that portions of functions are implemented at different physical locations by one or more physical components. In some examples, the communications manager 1115, or its sub-components, may be a separate and distinct component in accordance with various aspects of the present disclosure. In some examples, the communications manager 1115, or its sub-components, may be combined with one or more other hardware components, including but not limited to an I/O component, a transceiver, a network server, another computing device, one or more other components described in the present disclosure, or a combination thereof in accordance with various aspects of the present disclosure.

Transmitter 1120 may transmit signals generated by other components of the device. In some examples, the transmitter 1120 may be collocated with a receiver 1110 in a transceiver module. For example, the transmitter 1120 may be an example of aspects of the transceiver 1420 described with reference to FIG. 14. The transmitter 1120 may utilize a single antenna or a set of antennas.

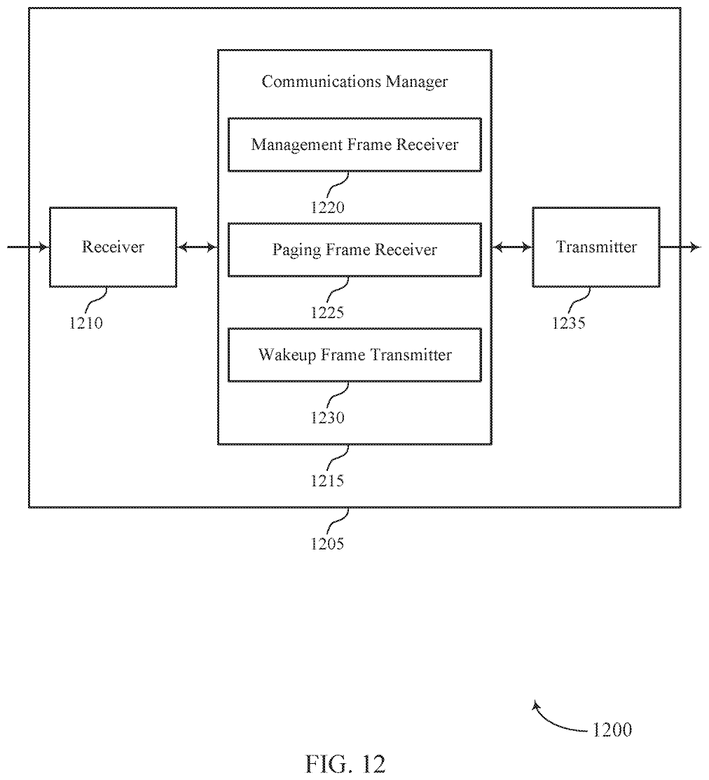

FIG. 12 shows a block diagram 1200 of a device 1205 that supports token wakeup signaling in accordance with aspects of the present disclosure. The device 1205 may be an example of aspects of a device 1105 or a STA 115 as described herein. The device 1205 may include a receiver 1210, a communications manager 1215, and a transmitter 1235. The device 1205 may also include a processor. Each of these components may be in communication with one another (e.g., via one or more buses).

Receiver 1210 may receive information such as packets, user data, or control information associated with various information channels (e.g., control channels, data channels, and information related to token wakeup signaling). Information may be passed on to other components of the device. The receiver 1210 may be an example of aspects of the transceiver 1420 described with reference to FIG. 14. The receiver 1210 may utilize a single antenna or a set of antennas.

The communications manager 1215 may be an example of aspects of the communications manager 1115 as described herein. The communications manager 1215 may include a management frame receiver 1220, a paging frame receiver 1225, and a wakeup frame transmitter 1230. The communications manager 1215 may be an example of aspects of the communications manager 1410 described herein.

The management frame receiver 1220 may receive a management frame from an AP 105 via a main radio connection with the AP, where the management frame includes an indication of a set of wakeup tokens for the STA.

The paging frame receiver 1225 may receive a WUR paging frame from the AP 105 via a WUR connection, where the WUR paging frame includes a wakeup token of the set of wakeup tokens for the STA.

The wakeup frame transmitter 1230 may transmit a wakeup ACK frame to the AP 105 via the main radio connection with the AP 105 in response to the WUR paging frame.

Transmitter 1235 may transmit signals generated by other components of the device. In some examples, the transmitter 1235 may be collocated with a receiver 1210 in a transceiver module. For example, the transmitter 1235 may be an example of aspects of the transceiver 1420 described with reference to FIG. 14. The transmitter 1235 may utilize a single antenna or a set of antennas.

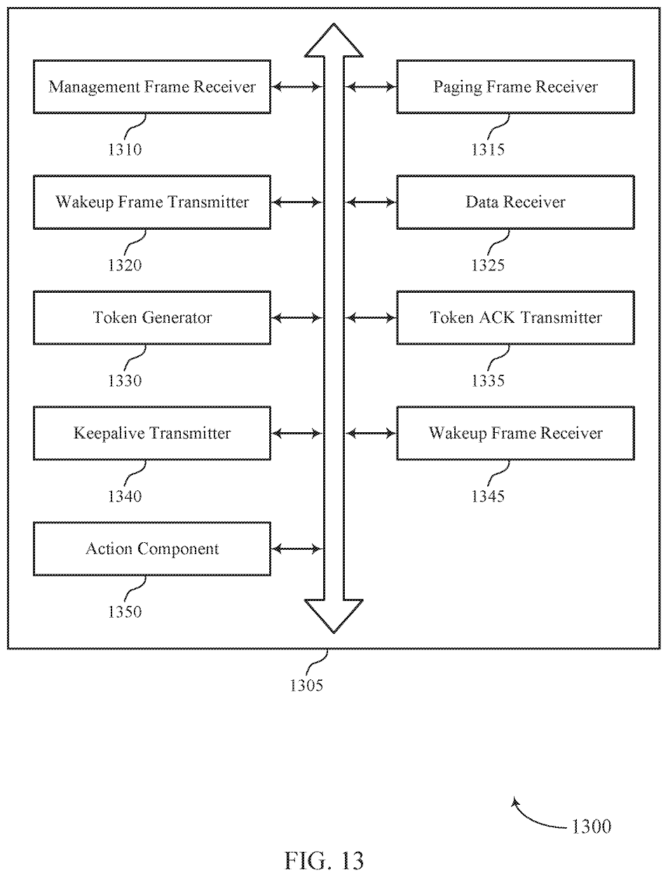

FIG. 13 shows a block diagram 1300 of a communications manager 1305 that supports token wakeup signaling in accordance with aspects of the present disclosure. The communications manager 1305 may be an example of aspects of a communications manager 1115, a communications manager 1215, or a communications manager 1410 described herein. The communications manager 1305 may include a management frame receiver 1310, a paging frame receiver 1315, a wakeup frame transmitter 1320, a data receiver 1325, a token generator 1330, a token ACK transmitter 1335, a keepalive transmitter 1340, a wakeup frame receiver 1345, and an action component 1350. Each of these modules may communicate, directly or indirectly, with one another (e.g., via one or more buses).

The management frame receiver 1310 may receive a management frame from an AP 105 via a main radio connection with the AP, where the management frame includes an indication of a set of wakeup tokens for the STA. In some examples, the management frame receiver 1310 may receive an indication of a second set of wakeup tokens for the STA 115 based on the periodic keepalive message. In some cases, the main radio connection is a secure connection. In some aspects, the set of wakeup tokens is unique to the STA.

The paging frame receiver 1315 may receive a WUR paging frame from the AP 105 via a WUR connection, where the WUR paging frame includes a wakeup token of the set of wakeup tokens for the STA. In some cases, the WUR connection is an insecure connection.

The wakeup frame transmitter 1320 may transmit a wakeup ACK frame to the AP 105 via the main radio connection with the AP 105 in response to the WUR paging frame.

The data receiver 1325 may receive a data transmission from the AP 105 in response to the wakeup ACK frame.

The token generator 1330 may identify a sequence number and a set size corresponding to the set of wakeup tokens based on the indication of the set of wakeup tokens. In some examples, the token generator 1330 may generate the set of wakeup tokens based on the sequence number and the set size.

The token ACK transmitter 1335 may transmit a token ACK frame to the AP 105 in response to the management frame, where the WUR paging frame is received based on the token ACK frame.

The keepalive transmitter 1340 may transmit a periodic keepalive message to the AP.

The wakeup frame receiver 1345 may receive the WUR paging frame for a group of STAs including the STA 115 via a broadcast channel.

The action component 1350 may identify an action associated with the wakeup token. In some examples, the action component 1350 may perform the action.

FIG. 14 shows a diagram of a system 1400 including a device 1405 that supports token wakeup signaling in accordance with aspects of the present disclosure. The device 1405 may be an example of or include the components of device 1105, device 1205, or a STA 115 as described herein. The device 1405 may include components for bi-directional voice and data communications including components for transmitting and receiving communications, including a communications manager 1410, an I/O controller 1415, a transceiver 1420, an antenna 1425, memory 1430, and a processor 1440. These components may be in electronic communication via one or more buses (e.g., bus 1445).

The communications manager 1410 may receive a management frame from an AP 105 via a main radio connection with the AP 105, where the management frame includes an indication of a set of wakeup tokens for the STA 115 and receive a WUR paging frame from the AP 105 via a WUR connection, where the WUR paging frame includes a wakeup token of the set of wakeup tokens for the STA 115. The communications manager 1410 may transmit a wakeup ACK frame to the AP 105 via the main radio connection with the AP 105 in response to the WUR paging frame.

I/O controller 1415 may manage input and output signals for device 1405. I/O controller 1415 may also manage peripherals not integrated into device 1405. In some cases, I/O controller 1415 may represent a physical connection or port to an external peripheral. In some cases, I/O controller 1415 may utilize an operating system such as iOS®, ANDROID®, MS-DOS®, MS-WINDOWS®, OS/2®, UNIX®, LINUX®, or another known operating system. In other cases, I/O controller 1415 may represent or interact with a modem, a keyboard, a mouse, a touchscreen, or a similar device. In some cases, I/O controller 1415 may be implemented as part of a processor. In some cases, a user may interact with device 1405 via I/O controller 1415 or via hardware components controlled by I/O controller 1415.

Transceiver 1420 may communicate bi-directionally, via one or more antennas, wired, or wireless links as described herein. For example, the transceiver 1420 may represent a wireless transceiver and may communicate bi-directionally with another wireless transceiver. The transceiver 1420 may also include a modem to modulate the packets and provide the modulated packets to the antennas for transmission, and to demodulate packets received from the antennas.

In some cases, the wireless device may include a single antenna 1425. However, in some cases the device may have more than one antenna 1425, which may be capable of concurrently transmitting or receiving multiple wireless transmissions.

Memory 1430 may include RAM and ROM. The memory 1430 may store computer-readable, computer-executable software 1435 including instructions that, when executed, cause the processor to perform various functions described herein. In some cases, the memory 1430 may contain, among other things, a BIOS which may control basic hardware or software operation such as the interaction with peripheral components or devices.

Processor 1440 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1440 may be configured to operate a memory array using a memory controller. In other cases, a memory controller may be integrated into processor 1440. Processor 1440 may be configured to execute computer-readable instructions stored in a memory to perform various functions (e.g., functions or tasks supporting token wakeup signaling).

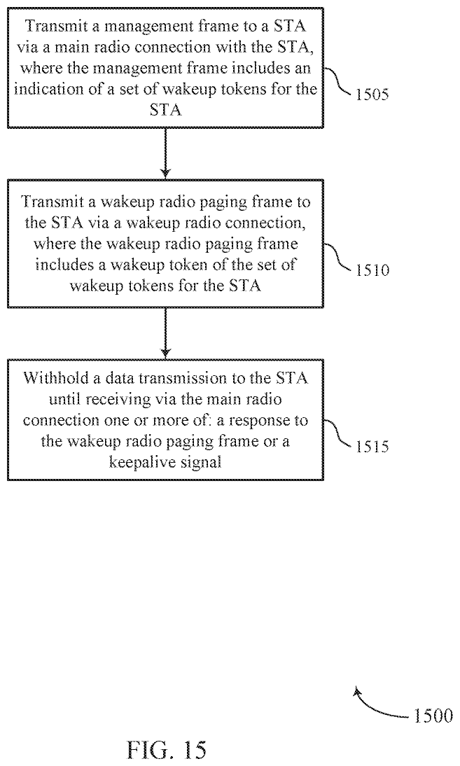

FIG. 15 shows a flowchart illustrating a method 1500 that supports token wakeup signaling in accordance with aspects of the present disclosure. The operations of method 1500 may be implemented by an AP 105 or its components as described herein. For example, the operations of method 1500 may be performed by a communications manager as described with reference to FIGS. 7 through 10. In some examples, an AP 105 may execute a set of instructions to control the functional elements of the AP 105 to perform the functions described herein. Additionally or alternatively, an AP 105 may perform aspects of the functions described herein using special-purpose hardware.

At 1505, the AP 105 may transmit a management frame to a STA 115 via a main radio connection with the STA, where the management frame includes an indication of a set of wakeup tokens for the STA. The operations of 1505 may be performed according to the methods described herein. In some examples, aspects of the operations of 1505 may be performed by a management frame transmitter as described with reference to FIGS. 7 through 10.

At 1510, the AP 105 may transmit a WUR paging frame to the STA 115 via a WUR connection, where the WUR paging frame includes a wakeup token of the set of wakeup tokens for the STA 115. The operations of 1510 may be performed according to the methods described herein. In some examples, aspects of the operations of 1510 may be performed by a paging frame component as described with reference to FIGS. 7 through 10.

At 1515, the AP 105 may withhold a data transmission to the STA 115 until receiving via the main radio connection one or more of a response to the WUR paging frame or a keepalive signal. The operations of 1515 may be performed according to the methods described herein. In some examples, aspects of the operations of 1515 may be performed by a data component as described with reference to FIGS. 7 through 10.

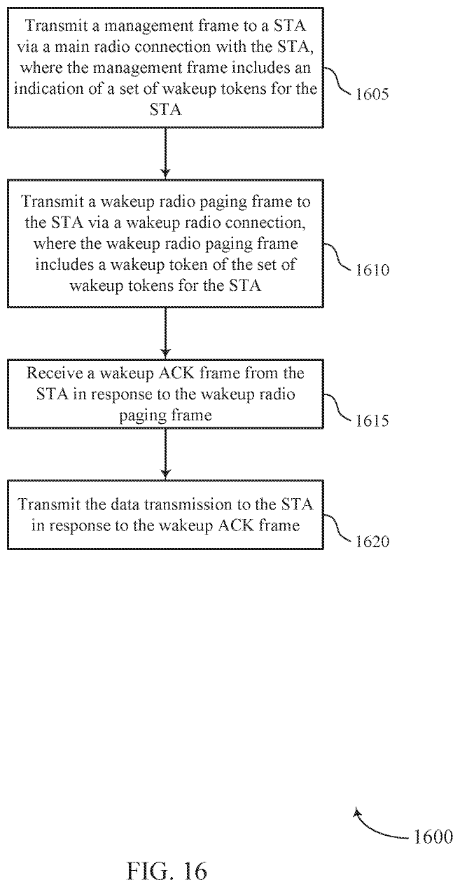

FIG. 16 shows a flowchart illustrating a method 1600 that supports token wakeup signaling in accordance with aspects of the present disclosure. The operations of method 1600 may be implemented by an AP 105 or its components as described herein. For example, the operations of method 1600 may be performed by a communications manager as described with reference to FIGS. 7 through 10. In some examples, an AP 105 may execute a set of instructions to control the functional elements of the AP 105 to perform the functions described herein. Additionally or alternatively, an AP 105 may perform aspects of the functions described herein using special-purpose hardware.

At 1605, the AP 105 may transmit a management frame to a STA 115 via a main radio connection with the STA, where the management frame includes an indication of a set of wakeup tokens for the STA. The operations of 1605 may be performed according to the methods described herein. In some examples, aspects of the operations of 1605 may be performed by a management frame transmitter as described with reference to FIGS. 7 through 10.

At 1610, the AP 105 may transmit a WUR paging frame to the STA 115 via a WUR connection, where the WUR paging frame includes a wakeup token of the set of wakeup tokens for the STA 115. The operations of 1610 may be performed according to the methods described herein. In some examples, aspects of the operations of 1610 may be performed by a paging frame component as described with reference to FIGS. 7 through 10.

At 1615, the AP 105 may receive a wakeup ACK frame from the STA 115 in response to the WUR paging frame. The operations of 1615 may be performed according to the methods described herein. In some examples, aspects of the operations of 1615 may be performed by a wakeup frame receiver as described with reference to FIGS. 7 through 10.

At 1620, the AP 105 may transmit the data transmission to the STA 115 in response to the wakeup ACK frame. The operations of 1620 may be performed according to the methods described herein. In some examples, aspects of the operations of 1620 may be performed by a data component as described with reference to FIGS. 7 through 10.

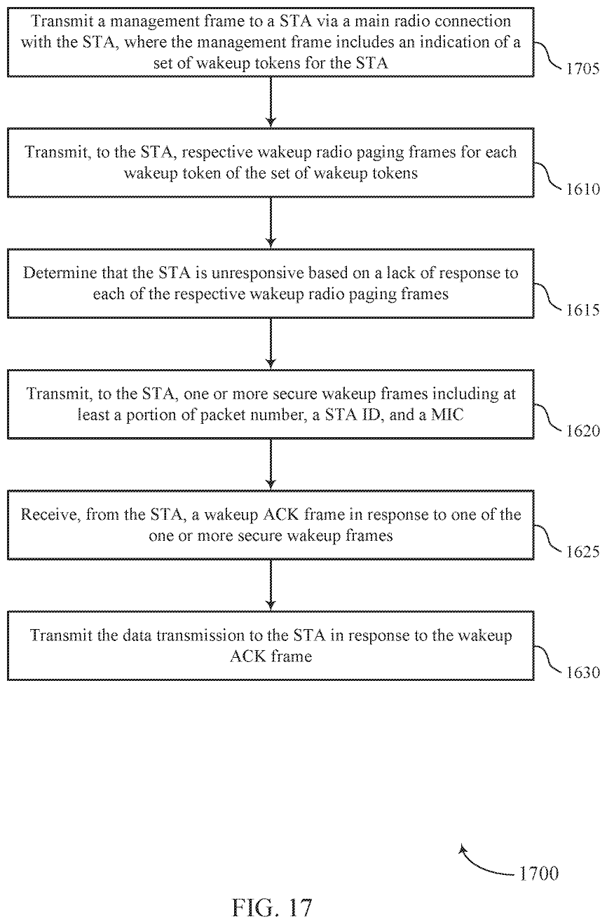

FIG. 17 shows a flowchart illustrating a method 1700 that supports token wakeup signaling in accordance with aspects of the present disclosure. The operations of method 1700 may be implemented by an AP 105 or its components as described herein. For example, the operations of method 1700 may be performed by a communications manager as described with reference to FIGS. 7 through 10. In some examples, an AP 105 may execute a set of instructions to control the functional elements of the AP 105 to perform the functions described herein. Additionally or alternatively, an AP 105 may perform aspects of the functions described herein using special-purpose hardware.

At 1705, the AP 105 may transmit a management frame to a STA 115 via a main radio connection with the STA, where the management frame includes an indication of a set of wakeup tokens for the STA. The operations of 1705 may be performed according to the methods described herein. In some examples, aspects of the operations of 1705 may be performed by a management frame transmitter as described with reference to FIGS. 7 through 10.

At 1710, the AP 105 may transmit, to the STA, respective WUR paging frames for each wakeup token of the set of wakeup tokens. The operations of 1710 may be performed according to the methods described herein. In some examples, aspects of the operations of 1710 may be performed by a paging frame component as described with reference to FIGS. 7 through 10.

At 1715, the AP 105 may determine that the STA 115 is unresponsive based on a lack of response to each of the respective WUR paging frames. The operations of 1715 may be performed according to the methods described herein. In some examples, aspects of the operations of 1715 may be performed by a determination component as described with reference to FIGS. 7 through 10.

At 1720, the AP 105 may transmit, to the STA 115, one or more secure wakeup frames including at least a portion of packet number, a STA ID, and a MIC. The operations of 1720 may be performed according to the methods described herein. In some examples, aspects of the operations of 1720 may be performed by a secure wakeup component as described with reference to FIGS. 7 through 10.

At 1725, the AP 105 may receive, from the STA, a wakeup ACK frame in response to one of the one or more secure wakeup frames. The operations of 1725 may be performed according to the methods described herein. In some examples, aspects of the operations of 1725 may be performed by a wakeup frame receiver as described with reference to FIGS. 7 through 10.

At 1730, the AP 105 may transmit the data transmission to the STA 115 in response to the wakeup ACK frame. The operations of 1730 may be performed according to the methods described herein. In some examples, aspects of the operations of 1730 may be performed by a data component as described with reference to FIGS. 7 through 10.

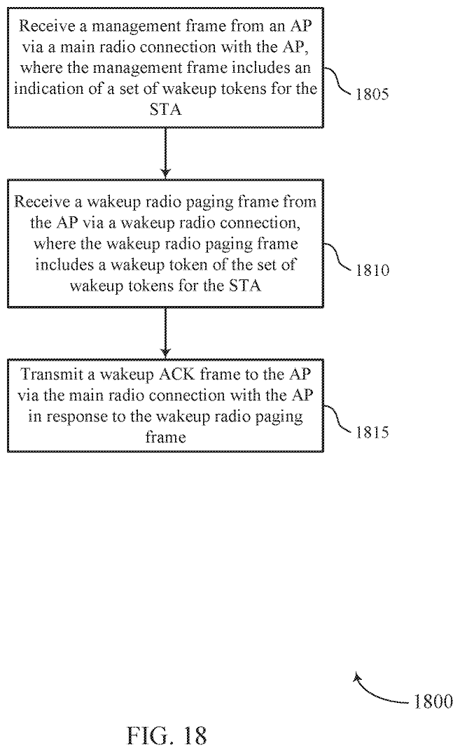

FIG. 18 shows a flowchart illustrating a method 1800 that supports token wakeup signaling in accordance with aspects of the present disclosure. The operations of method 1800 may be implemented by a STA 115 or its components as described herein. For example, the operations of method 1800 may be performed by a communications manager as described with reference to FIGS. 11 through 14. In some examples, a STA 115 may execute a set of instructions to control the functional elements of the STA 115 to perform the functions described herein. Additionally or alternatively, a STA 115 may perform aspects of the functions described herein using special-purpose hardware.

At 1805, the STA 115 may receive a management frame from an AP 105 via a main radio connection with the AP, where the management frame includes an indication of a set of wakeup tokens for the STA. The operations of 1805 may be performed according to the methods described herein. In some examples, aspects of the operations of 1805 may be performed by a management frame receiver as described with reference to FIGS. 11 through 14.

At 1810, the STA 115 may receive a WUR paging frame from the AP 105 via a WUR connection, where the WUR paging frame includes a wakeup token of the set of wakeup tokens for the STA 115. The operations of 1810 may be performed according to the methods described herein. In some examples, aspects of the operations of 1810 may be performed by a paging frame receiver as described with reference to FIGS. 11 through 14.

At 1815, the STA 115 may transmit a wakeup ACK frame to the AP 105 via the main radio connection with the AP 105 in response to the WUR paging frame. The operations of 1815 may be performed according to the methods described herein. In some examples, aspects of the operations of 1815 may be performed by a wakeup frame transmitter as described with reference to FIGS. 11 through 14.

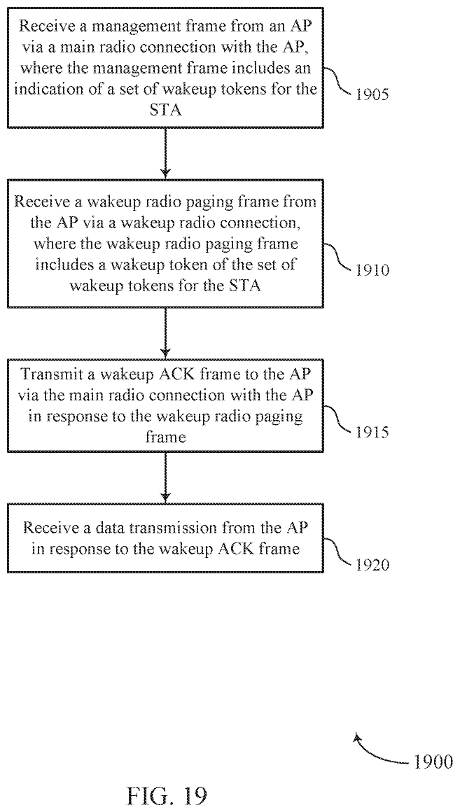

FIG. 19 shows a flowchart illustrating a method 1900 that supports token wakeup signaling in accordance with aspects of the present disclosure. The operations of method 1900 may be implemented by a STA 115 or its components as described herein. For example, the operations of method 1900 may be performed by a communications manager as described with reference to FIGS. 11 through 14. In some examples, a STA 115 may execute a set of instructions to control the functional elements of the STA 115 to perform the functions described herein. Additionally or alternatively, a STA 115 may perform aspects of the functions described herein using special-purpose hardware.

At 1905, the STA 115 may receive a management frame from an AP 105 via a main radio connection with the AP 105, where the management frame includes an indication of a set of wakeup tokens for the STA 115. The operations of 1905 may be performed according to the methods described herein. In some examples, aspects of the operations of 1905 may be performed by a management frame receiver as described with reference to FIGS. 11 through 14.

At 1910, the STA 115 may receive a WUR paging frame from the AP 105 via a WUR connection, where the WUR paging frame includes a wakeup token of the set of wakeup tokens for the STA 115. The operations of 1910 may be performed according to the methods described herein. In some examples, aspects of the operations of 1910 may be performed by a paging frame receiver as described with reference to FIGS. 11 through 14.

At 1915, the STA 115 may transmit a wakeup ACK frame to the AP 105 via the main radio connection with the AP 105 in response to the WUR paging frame. The operations of 1915 may be performed according to the methods described herein. In some examples, aspects of the operations of 1915 may be performed by a wakeup frame transmitter as described with reference to FIGS. 11 through 14.

At 1920, the STA 115 may receive a data transmission from the AP 105 in response to the wakeup ACK frame. The operations of 1920 may be performed according to the methods described herein. In some examples, aspects of the operations of 1920 may be performed by a data receiver as described with reference to FIGS. 11 through 14.

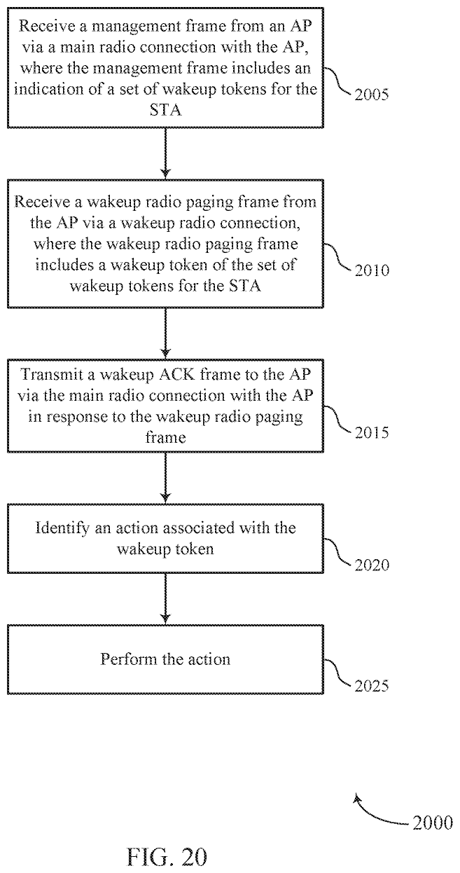

FIG. 20 shows a flowchart illustrating a method 2000 that supports token wakeup signaling in accordance with aspects of the present disclosure. The operations of method 2000 may be implemented by a STA 115 or its components as described herein. For example, the operations of method 2000 may be performed by a communications manager as described with reference to FIGS. 11 through 14. In some examples, a STA 115 may execute a set of instructions to control the functional elements of the STA 115 to perform the functions described herein. Additionally or alternatively, a STA 115 may perform aspects of the functions described herein using special-purpose hardware.

At 2005, the STA 115 may receive a management frame from an AP 105 via a main radio connection with the AP, where the management frame includes an indication of a set of wakeup tokens for the STA 115. The operations of 2005 may be performed according to the methods described herein. In some examples, aspects of the operations of 2005 may be performed by a management frame receiver as described with reference to FIGS. 11 through 14.

At 2010, the STA 115 may receive a WUR paging frame from the AP 105 via a WUR connection, where the WUR paging frame includes a wakeup token of the set of wakeup tokens for the STA 115. The operations of 2010 may be performed according to the methods described herein. In some examples, aspects of the operations of 2010 may be performed by a paging frame receiver as described with reference to FIGS. 11 through 14.

At 2015, the STA 115 may transmit a wakeup ACK frame to the AP 105 via the main radio connection with the AP 105 or via the low power radio connection with the AP 105 in response to the WUR paging frame. The operations of 2015 may be performed according to the methods described herein. In some examples, aspects of the operations of 2015 may be performed by a wakeup frame transmitter as described with reference to FIGS. 11 through 14.

At 2020, the STA 115 may identify an action associated with the wakeup token. The operations of 2020 may be performed according to the methods described herein. In some examples, aspects of the operations of 2020 may be performed by an action component as described with reference to FIGS. 11 through 14.

At 2025, the STA 115 may perform the action. The operations of 2025 may be performed according to the methods described herein. In some examples, aspects of the operations of 2025 may be performed by an action component as described with reference to FIGS. 11 through 14.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can include RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at an access point (AP), comprising:
transmitting a management frame to a station (STA) via a main radio connection with the STA, wherein the management frame comprises an indication of a set of wakeup tokens for the STA;
transmitting a wakeup radio paging frame to the STA via a wakeup radio connection, wherein the wakeup radio paging frame comprises a wakeup token of the set of wakeup tokens for the STA; and
withholding a data transmission to the STA until receiving via the main radio connection one or more of: a response to the wakeup radio paging frame or a keepalive signal.

2. The method of claim 1, further comprising:
receiving a wakeup acknowledgement (ACK) frame from the STA in response to the wakeup radio paging frame; and
transmitting the data transmission to the STA in response to the wakeup ACK frame.

3. The method of claim 1, further comprising:
transmitting, to the STA, respective wakeup radio paging frames for each wakeup token of the set of wakeup tokens.

4. The method of claim 3, further comprising:
receiving a wakeup acknowledgement (ACK) frame from the STA in response to at least one of the respective wakeup radio paging frames; and
transmitting the data transmission to the STA in response to the wakeup ACK frame.

5. The method of claim 3, further comprising:
determining that the STA is unresponsive based at least in part on a lack of response to each of the respective wakeup radio paging frames;
transmitting, to the STA, one or more secure wakeup frames comprising at least a portion of packet number, a STA identifier (ID), and a message integrity check (MIC);
receiving, from the STA, a wakeup acknowledgement (ACK) frame in response to one of the one or more secure wakeup frames; and
transmitting the data transmission to the STA in response to the wakeup ACK frame.

6. The method of claim 1, further comprising:
receiving a token acknowledgement (ACK) frame from the STA in response to the management frame, wherein the wakeup radio paging frame is transmitted based at least in part on the token ACK frame.

7. The method of claim 1, further comprising:
selecting the set of wakeup tokens for the STA from a group of preconfigured wakeup tokens.

8. The method of claim 1, wherein transmitting the management frame comprises:
transmitting a sequence number and a set size corresponding to the set of wakeup tokens.

9. The method of claim 1, further comprising:
receiving a periodic keepalive message from the STA; and
transmitting an indication of a second set of wakeup tokens to the STA based at least in part on the periodic keepalive message.

10. The method of claim 1, wherein the wakeup token is associated with an action to be performed by the STA.

11. The method of claim 1, wherein transmitting the wakeup radio paging frame comprises:
broadcasting the wakeup radio paging frame to a group of STAs including the STA.

12. The method of claim 1, wherein transmitting the management frame comprises:
generating a wakeup radio mode field of the management frame, the wakeup radio mode field comprising the indication of the set of wakeup tokens.

13. The method of claim 1, wherein transmitting the wakeup radio paging frame comprises:
generating a frame control field and a wakeup control field of the wakeup radio paging frame, the wakeup control field indicating the wakeup token.

14. The method of claim 1, wherein:
the main radio connection is a secure connection; and
the wakeup radio connection is an insecure connection.

15. The method of claim 1, wherein the set of wakeup tokens is unique to the STA.

16. A method for wireless communications at a station (STA), comprising:
receiving a management frame from an access point (AP) via a main radio connection with the AP, wherein the management frame comprises an indication of a set of wakeup tokens for the STA;
receiving a wakeup radio paging frame from the AP via a wakeup radio connection, wherein the wakeup radio paging frame comprises a wakeup token of the set of wakeup tokens for the STA; and
transmitting a wakeup acknowledgement (ACK) frame to the AP via the main radio connection with the AP in response to the wakeup radio paging frame.

17. The method of claim 16, further comprising:
receiving a data transmission from the AP in response to the wakeup ACK frame.

18. The method of claim 16, further comprising:
identifying a sequence number and a set size corresponding to the set of wakeup tokens based at least in part on the indication of the set of wakeup tokens; and
generating the set of wakeup tokens based at least in part on the sequence number and the set size.

19. The method of claim 16, further comprising:
transmitting a token acknowledgement (ACK) frame to the AP in response to the management frame, wherein the wakeup radio paging frame is received based at least in part on the token ACK frame.

20. The method of claim 16, further comprising:
transmitting a periodic keepalive message to the AP; and
receiving an indication of a second set of wakeup tokens for the STA based at least in part on the periodic keepalive message.

21. The method of claim 16, wherein receiving the wakeup radio paging frame comprises:
receiving the wakeup radio paging frame for a group of STAs including the STA via a broadcast channel.

22. The method of claim 16, further comprising:
identifying an action associated with the wakeup token; and
performing the action.

23. The method of claim 16, wherein:
the main radio connection is a secure connection; and
the wakeup radio connection is an insecure connection.

24. The method of claim 16, wherein the set of wakeup tokens is unique to the STA.

25. An apparatus for wireless communications at an access point (AP), comprising:
a first interface;
a second interface; and
a wireless modem coupled with the first interface and the second interface, wherein the wireless modem is configured to:
output over the first interface a management frame for transmission to a station (STA) via a main radio connection with the STA, wherein the management frame comprises an indication of a set of wakeup tokens for the STA;
output over the first interface a wakeup radio paging frame for transmission to the STA via a wakeup radio connection, wherein the wakeup radio paging frame comprises a wakeup token of the set of wakeup tokens for the STA; and
withhold a data transmission to the STA until obtaining over the second interface via the main radio connection one or more of: a response to the wakeup radio paging frame or a keepalive signal.

26. The apparatus of claim 25, wherein the wireless modem is further configured to:
obtain over the second interface a wakeup acknowledgement (ACK) frame from the STA in response to the wakeup radio paging frame; and
output the data transmission over the first interface for transmission to the STA in response to the wakeup ACK frame.

27. The apparatus of claim 25, wherein the wireless modem is further configured to:
output over the first interface, for transmission to the STA, respective wakeup radio paging frames for each wakeup token of the set of wakeup tokens.

28. An apparatus for wireless communications at a station (STA), comprising:
a first interface;
a second interface; and
a wireless modem coupled with the first interface and the second interface, wherein the wireless modem is configured to:
obtain over the first interface a management frame from an access point (AP) via a main radio connection with the AP, wherein the management frame comprises an indication of a set of wakeup tokens for the STA;
obtain over the first interface a wakeup radio paging frame from the AP via a wakeup radio connection, wherein the wakeup radio paging frame comprises a wakeup token of the set of wakeup tokens for the STA; and
output over the second interface a wakeup acknowledgement (ACK) frame for transmission to the AP via the main radio connection with the AP in response to the wakeup radio paging frame.

29. The apparatus of claim 28, wherein the wireless modem is further configured to:
obtain over the first interface a data transmission from the AP in response to the wakeup ACK frame.

30. The apparatus of claim 28, wherein the wireless modem is further configured to:
identify a sequence number and a set size corresponding to the set of wakeup tokens based at least in part on the indication of the set of wakeup tokens; and
generate the set of wakeup tokens based at least in part on the sequence number and the set size.
